(19) United States
(12) Patent Application Publication
(10) Pub. No.: US 2007/0159562 A1
(43) Pub. Date: Jul. 12, 2007

(54) Device and method for manufacturing an electro-active spectacle lens involving a mechanically flexible integration insert

(76) Inventors: Joshua N. Haddock, (US); William Kokonaski, Gig Harbor, WA (US); Ronald D. Blum, Roanoke, VA (US); Venkatramani S. Iyer, Roanoke, VA (US); Dwight P. Duston, Laguna Niguel, CA (US)

Correspondence Address: PEARL COHEN ZEDEK LATZER, LLP, 1500 BROADWAY 12TH FLOOR, NEW YORK, NY, 10036, US

(21) Appl. No.: 11/651,110

(22) Filed: Jan. 9, 2007

Related U.S. Application Data
(60) Provisional application No. 60/757,382, filed on Jan. 10, 2006.
(60) Provisional application No. 60/759,814, filed on Jan. 19, 2006.

(51) Int. Cl. G02F 1/1335

(52) U.S. Cl. 349/13

(57) ABSTRACT

An improved device and method for manufacturing electro-active spectacle lenses comprising electronic, electro-active optical, and bulk refractive optical elements is presented. In this method, electronic and electro-active optical elements are mounted to an optically transparent and mechanically flexible integration insert which is separate from any bulk refractive optical element(s). This method is advantageous for the manufacture of such spectacle lenses in that it allows for the mass production of many of the individual elements and enables the integration of the insert with the bulk refractive optical element(s) by multiple means. One such approach involves attaching the insert with a transparent adhesive to a rigid optical substrate and then encapsulating it by means of surface casting. Alternatively, the insert may be placed between the surfaces of a mold filled with an optical resin and encapsulated within the bulk refractive element as the resin is cured.

### CROSS REFERENCE TO RELATED APPLICATIONS

This application claims priority from and incorporates by reference in their entirety the following provisional applications:

U.S. Ser. No. 60/757,382 filed on Jan. 10, 2006 and entitled “Improved method for manufacturing an electro-active spectacle lens involving a mechanically flexible integration insert”; and

U.S. Ser. No. 60/759,814 filed on Jan. 19, 2006 and entitled “Improved method for manufacturing an electro-active spectacle lens involving a mechanically flexible integration insert”.

### BACKGROUND OF THE INVENTION

1. Field of the Invention

The present invention relates to an electro-active spectacle lens and methods for manufacturing the electro-active spectacle lenses.

2. Description of the Related Art

Presbyopia is the loss of accommodation of the crystalline lens of the human eye, a condition that results in the inability to focus on near objects. The standard tools for correcting presbyopia are multi-focal spectacle lenses. A multi-focal lens is a lens that has more than one focal length (i.e. optical power) for the purpose of correcting focusing problems across a range of distances. Multi-focal spectacle lenses work by means of a division of area where a relatively large portion of the lens corrects for distance vision errors (if any) and a small portion, located near the bottom edge of the lens, provides additional optical power to correct for the effects of presbyopia. The transition between the regions of near and distance vision correction may be either abrupt, as is the case for bifocal and trifocal lenses, or smooth and continuous, as is the case with progressive lenses. There are issues associated with these two approaches that can be objectionable to some patients. The visible line of demarcation associated with bifocals can be aesthetically displeasing and the transition regions associated with progressive lenses can lead to blurred and distorted vision, which, in some patients, can lead to physical discomfort. Furthermore, the placement of the near vision correction area near the bottom edge of the lens requires patients to adopt a somewhat unnatural downward gaze for near vision tasks.

To resolve these issues, a multi-focal spectacle lens would have to be developed where, to avoid distortion, the area of near vision correction is larger, placed nearer to the center of the lens, and has no visible edges. What is proposed here is embedding an optical element within a conventional spectacle lens that can be turned on and off such that the element would provide substantially no optical add power in the deactivated state and the required optical add power(s) when activated. While many technologies could be approached as a solution to the problem, the rather restrictive form factor of spectacles and the need for low electrical power consumption limit what is feasible.

Liquid crystal based optics are an attractive solution as the refractive index of a liquid crystal can be changed by generating an electric field across the liquid crystal. Such an electric field is generated by applying one or more voltages to electrodes located on both sides of the liquid crystal. Liquid crystal can also provide the required range of optical add powers (Plano to +3.00D) necessary to correct for presbyopia. Finally, liquid crystal can be used to make large diameter optics (greater than 10 mm) which is the minimum size necessary to avoid user discomfort.

A thin layer of liquid crystal (less than 10 μm) may be used to construct the electro-active multi-focal optic. When a thin layer is employed, the shape and size of the electrode(s) may be used to induce certain optical effects within the lens. For example, a diffractive grating can be dynamically produced within the liquid crystal by using concentric ring shaped patterned electrodes. Such a grating can produce an optical add power based upon the radii of the rings, the widths of the rings, and the range of voltages separately applied to the different rings. Alternately, the electrodes may be “pixilated”, wherein the electrodes are patterned to form an array (i.e. pixels) to which any arbitrary pattern of voltages may be applied. Such an array of pixels may be, by way of example only, arranged in a Cartesian array or hexagonal array. While such an array of pixels can be used to generate optical add powers by emulating a diffractive, concentric ring electrode structure, it may also be used to correct for higher-order aberrations of the eye in a manner similar to that used to correct for atmospheric turbulence effects in ground based astronomy. This technique, referred to as adaptive optics, can be either refractive or diffractive and is well known in the art. In either of the above cases the required operating voltages for such thin layers of liquid crystal are quite low, typically less than 5 volts. Alternately, a single continuous electrode may be used with a specialized optical structure known as a surface relief optic. Such an optic contains a physical substrate which is patterned to have a fixed optical power and/or aberration correction. By applying voltage to the liquid crystal through the electrode, the power/aberration correction can be switched on and off by means of refractive index mismatching and matching, respectively.

A thicker layer of liquid crystal (typically >50 μm) may also be used to construct the electro-active multi-focal optic. For example, a modal lens may be employed to create a refractive optic. Known in the art, modal lenses incorporate a single, continuous low conductivity circular electrode surrounded by, and in electrical contact with, a single high conductivity ring-shaped electrode. Upon application of a single voltage to the high conductivity ring electrode, the low conductivity electrode, essentially a radially symmetric, electrically resistive network, produces a voltage gradient across the layer of liquid crystal, which subsequently induces a refractive index gradient in the liquid crystal. A layer of liquid crystal with a refractive index gradient will function as an electro-active lens and will focus light incident upon it. Regardless of the thickness of the liquid crystal layer, the electrode geometry or the errors of the eye that the electro-active element corrects for, such electro-active spectacle lenses could be fabricated in a manner very similar to liquid crystal displays and in doing so would benefit from the mature parent technology.

The commercialization of electro-active spectacle lenses will require a highly specialized manufacturing process. As with any manufacturing process, it is desirable to have as few individual components as possible and have as many of these components as possible be mass-producted. This is desirable as it both simplifies the assembly process and reduces the number of required stock keeping unit numbers (SKU's) for the individual components. The issue of reduced SKU's is especially important when dealing with spectacle lenses as one has to account for a wide range of variables such as sphero-cylindrical add powers, prism add powers, astigmatic axes, and interpupilary distances. Also, the manufacturing process should be tolerant of the various product configurations (i.e. patient prescriptions, frame styles, and frame sizes) so as to reduce the overall cost and amount of tooling required to process lenses to suit individual patient prescriptions. The manufacturing process detailed below addresses both of these issues to provide a manufacturing approach that is both insensitive to a patient's non-presbyopic vision corrections and which reduces the number of required SKU's by using a small number of mass produced components.

The invention contained herein will allow for the efficient fabrication of high quality optics in a very reproducible manner. The invention disclosed herein provides for electro-active lenses that in one embodiment corrects for conventional refractive error by having optical powers of sphere, cylinder or a combination of both. In another inventive embodiment the electro-active lens corrects for higher order aberrations in addition to the conventional refractive error by having optical powers of sphere, cylinder, or a combination of both with additionally localized changes of optical power that corrects for higher order aberrations. In each case the inventive embodiments can correct for presbyopia or simply distance vision. It should be pointed out that the inventive embodiments disclosed herein use the electro-active component to correct presbyopia by way of creating positive, spherical, optical add powers while the non-electro-active lens component is used to correct for conventional refractive error by way of static, refractive, optical add powers of sphere, cylinder or a combination of both. Further, the inventive embodiment contained herein can correct for higher order aberrations by either programming the electro-active array of pixels contained within the electro-active element or by way of localized changes in the non-electro-active component of the lens blank.

### SUMMARY OF THE INVENTION

In a first embodiment of the invention an electro-active spectacle lens is comprised of an optical element for providing a first optical power. The electro-active spectacle lens further comprises an insert which is disposed within the optical element. Lastly the electro-active spectacle lens further comprises an electro-active element in optical communication with the optical element and is positioned within the insert for providing a second optical power when activated and substantially no optical power when deactivated.

In a second embodiment of the invention, a method for manufacturing an electro-active spectacle lens is comprised of positioning an electro-active element within an insert for forming an assembled insert. The method for manufacturing an electro-active spectacle lens further comprises laminating a lens blank to a first face of the assembled insert with an optically transparent adhesive for producing a first optical surface of the electro-active spectacle lens. The method for manufacturing an electro-active spectacle lens further comprises positioning a mold over a second face of the assembled insert opposite the first face for forming a cavity between the mold and the lens blank. The method for manufacturing an electro-active spectacle lens further comprises filling the cavity with an optical resin. The method for manufacturing an electro-active spectacle lens further comprises curing the optical resin for producing a second optical surface of the electro-active spectacle lens.

In a third embodiment of the invention, a method for manufacturing an electro-active spectacle lens is comprised of positioning an electro-active element within an insert for forming an assembled insert. The method for manufacturing an electro-active spectacle lens further comprises mounting the assembled insert within a mold gasket. The method for manufacturing an electro-active spectacle lens further comprises positioning a first mold and a second mold on the mold gasket, wherein the first mold is opposite the second mold for forming a cavity between the first mold and the second mold. The method for manufacturing an electro-active spectacle lens further comprises filling the cavity with an optical resin. The method for manufacturing an electro-active spectacle lens further comprises curing the optical resin for producing a first and a second optical surface of the electro-active spectacle lens.

### DESCRIPTION OF THE DRAWINGS

FIG. 1 is a top-view drawing of a complete electro-active spectacle lens which includes the electronic, electro-active optical, and bulk refractive optical elements;

FIG. 2 is a top-view drawing of the mechanically flexible and optically transparent integration insert;

FIG. 3 is a top-view drawing of the integration insert with the addition of the transparent electrical leads;

FIG. 4 is a top-view drawing of the integration insert with the addition of the transparent electrical leads and integrated circuit drive electronics;

FIG. 5 is a close-up view of one arm of the integration insert showing 2 power supply leads and 9 drive signal leads which are connected to the integrated circuit;

FIG. 6a is a top view of a complete electro-active element constructed from two substrates with concentric ring patterned electrodes and a substrate with a single continuous electrode;

FIG. 6b is a top view of a substrate with concentric ring patterned electrodes;

FIG. 6c is a top view of a substrate with a single continuous electrode;

FIG. 6d is an exploded view along the axis A-A of the complete electro-active element of FIG. 6a;

FIG. 6e is a top view of an alternate complete electro-active element constructed from two substrates with surface relief diffractive structures coated with a single continuous electrode and a substrate with a single continuous electrode;

FIG. 6f is a top view of a substrate for the alternate electro-active element with a surface relief diffractive structure coated with a single continuous electrode;

FIG. 6g is a top view of a substrate with a single continuous electrode;

FIG. 6h is an exploded view along the axis A-A of the complete alternate electro-active element of FIG. 6e;

FIG. 6i is a top view of an alternate complete electro-active element constructed from two substrates with modal lens electrodes and a substrate with a single continuous electrode;

FIG. 6j is a top view of a substrate for the alternate electro-active element with modal lens electrodes;

FIG. 6k is a top view of a substrate with a single continuous electrode.

FIG. 6l is an exploded view along the axis A-A of the complete alternate electro-active element of FIG. 6i;

FIG. 7a shows a top view of an assembled integration insert.

FIG. 7b shows an exploded view along the axis A-A of FIG. 7a of the physical placement of the electro-active element within the integration insert so as to make electrical connection between the electro-active element and the integration insert;

FIG. 8a is a top-view of a fully assembled integration insert including all the electrical leads, drive electronics, and an electro-active element having patterned concentric ring electrodes arranged in a manner to generate a diffractive lens for providing optical add power;

FIG. 8b is a top-view of a fully assembled integration insert including all the electrical leads, drive electronics, and an electro-active element having patterned pixelated electrodes arranged in a manner to correct for any arbitrary optical error of the human eye;

FIG. 9a shows a fully-assembled insert and a finished lens blank as a first step in a first method of manufacturing an electro-active spectacle lens;

FIG. 9b shows the fully-assembled insert laminated to the finished lens blank as a second step in a first method of manufacturing an electro-active spectacle lens;

FIG. 9c shows resin filling a mold attached to the inverted, combined fully-assembled insert and finished lens blank as a third step in a first method of manufacturing an electro-active spectacle lens;

FIG. 9d shows the combined fully-assembled insert and finished lens blank after the resin is cured and the mold removed as a fourth step in a first method of manufacturing an electro-active spectacle lens;

FIG. 9e shows a combined fully-assembled insert and semi-finished lens blank after the resin is cured and the mold removed in an alternate first step in a first method of manufacturing an electro-active spectacle lens in which the fully-assembled insert is laminated to a semi-finished lens blank;

FIG. 10a shows a fully-assembled insert positioned within a mold gasket as a first step in a second method of manufacturing an electro-active spectacle lens;

FIG. 10b shows a first mold whose surface defines a finished lens blank attached to the mold gasket as a second step in a second method of manufacturing an electro-active spectacle lens;

FIG. 10c shows a second mold attached to the mold gasket after which the molds are filled with resin as a third step in a second method of manufacturing an electro-active spectacle lens;

FIG. 10d shows the combined fully-assembled insert and finished lens blank after the resin is cured and the molds and mold gasket are removed as a fourth step in a second method of manufacturing an electro-active spectacle lens; and

FIG. 10e shows a combined fully-assembled insert and semi-finished lens blank after the resin is cured and the molds and mold gasket are removed in an alternate second step in a second method of manufacturing an electro-active spectacle lens in which the electro-active spectacle lens is cast as a semi-finished lens blank.

### DESCRIPTION OF THE PREFERRED EMBODIMENT

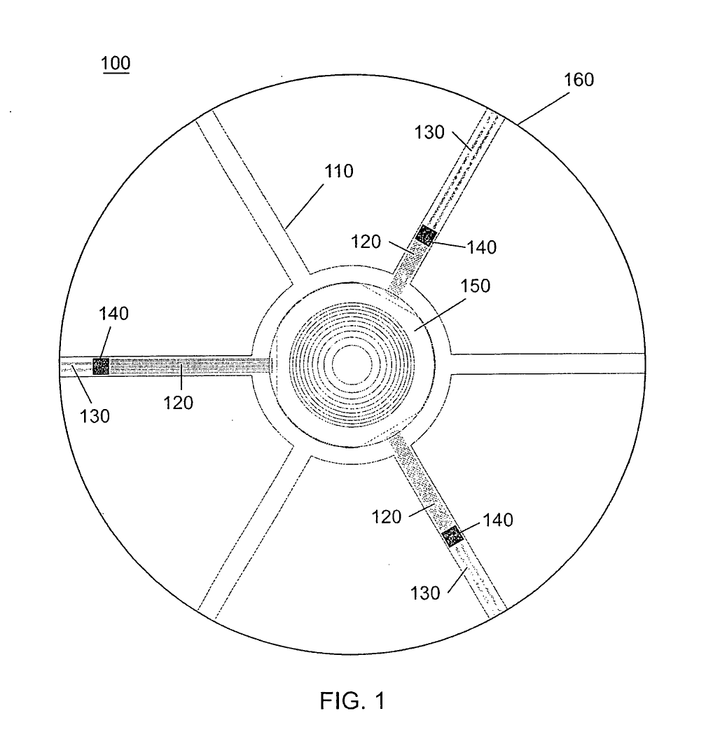

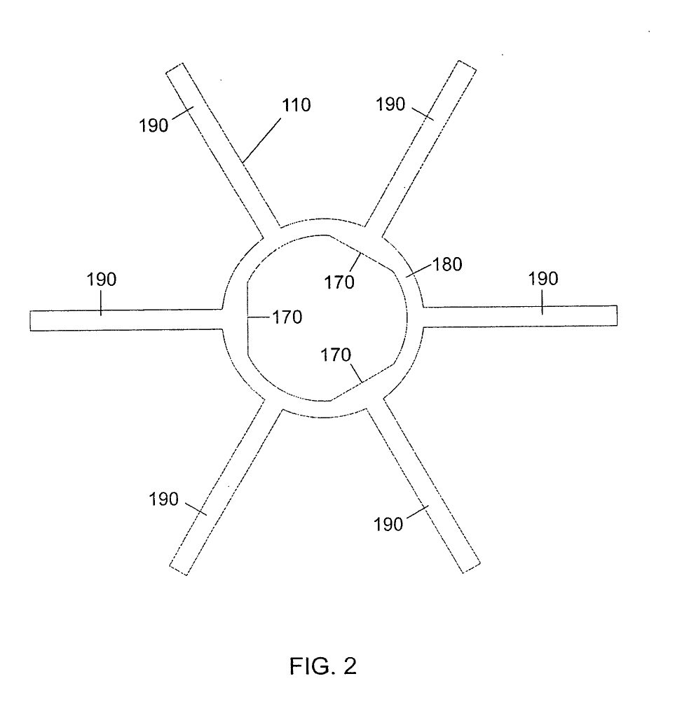

A top view drawing of an electro-active (EA) spectacle lens 100 manufactured by the proposed methods is shown in FIG. 1. This lens includes an integration insert 100 possessing transparent, thin film signal electrical leads 120 and battery electrical leads 130, to which an electro-active (EA) optical element 150 and integrated circuits 140 are attached. FIG. 2 shows the integration insert without any of the thin film electrical leads or integrated circuits applied. The central ring 180 and “arms” 190 of the integration insert 110 act to provide physical support when incorporating the EA element 150 within the bulk refractive optical element 160 and provide a platform for attaching transparent electrical leads 120 and 130 and integrated circuits 140 which are needed to operate the EA element. The EA element may have planar surfaces, curved surfaces or may be designed such that one surface is planar and the other is curved. In most but not all cases these surfaces are equidistant from each other. Integration insert 110 contains alignment edges 170 located within central ring 180 to aid aligning of the insert with EA element 150. The insert must be optically transparent (for obvious cosmetic reasons) and have the ability to conform to the various radii of curvature of a lens that exists for different distance vision prescriptions. If the insert did not conform to the radii of curvature of a lens for a distance prescription, a thicker lens would result which would be unacceptable to the wearer. As such, the insert can be either cut or stamped from flexible sheets of glass or plastic whose thicknesses range from 50 μm to 150 μm. Sheet glass is commercially available with thicknesses down to 30 μm (Schott® D 263 T and AF 45) and many different types of plastics are available in comparable thicknesses. While the integration insert is shown here as comprising a central ring 180 with an opening and separate arms 190 extending radially from said ring, the insert need not be this shape. In certain other embodiments, the insert may take any form which includes an opening for an EA element and material peripheral to the opening for supporting thin-film signal electrical leads, thin-film battery electrical leads, and integrated circuits. By way of example only, the insert may be a flat toroidal shape, with a central opening and alignment edges.

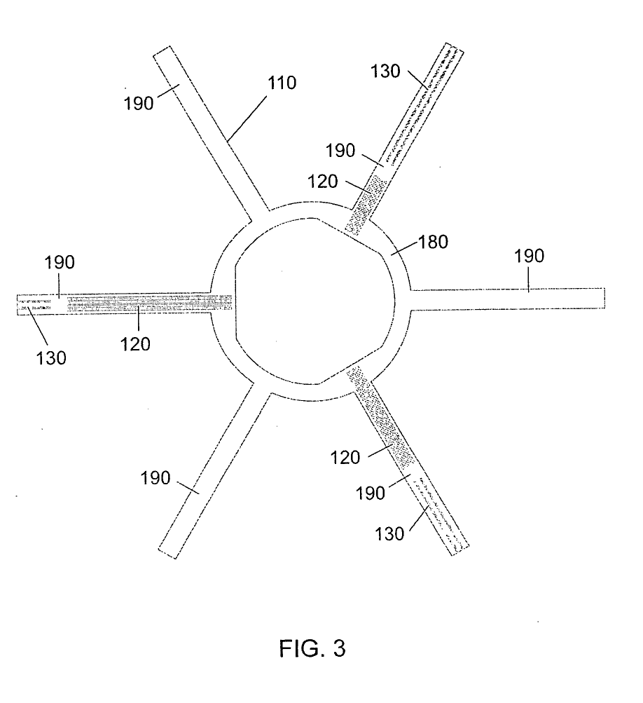

Electrical leads 120 and 130 can be made from thin films of transparent conductive oxides (e.g. ITO, ZnO, SnO₂) or conducting polymers (e.g. polyaniline, PEDOT:PSS) and are applied to the surface(s) of the insert 110 as shown in FIG. 3. The electrical leads may be added to the insert by means of either additive or subtractive processes. Additive processes would include (for example) screen printing or thin-film deposition through a shadow mask of the electrical lead material. Subtractive processes would include (for example) either partially or completely coating the insert with the desired material and then removing the excess by means of either a patterned etch resist or a direct write laser ablation process. In embodiments of the invention, the thickness of the material from which the leads are constructed may be 1 μm or less and in preferred embodiments, the thickness is 100 nm or less. In other embodiments of the invention the leads may be placed on both faces of the insert.

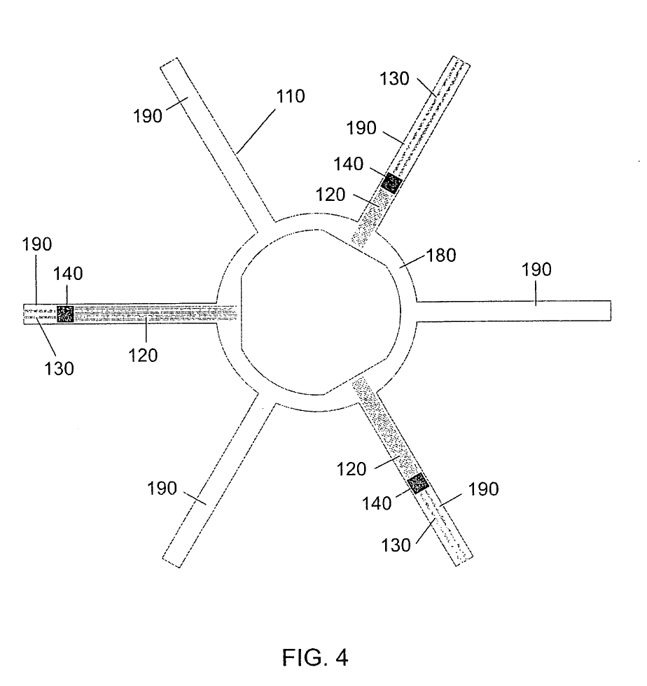

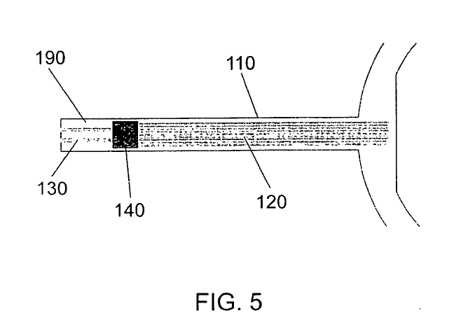

The electrical leads allow an integrated circuit (IC) 140, which contains the drive electronics for the EA element, to be directly mounted to the insert as illustrated in FIG. 4. A close-up view of one of the arms is shown in FIG. 5 where, by way of example only, 2 power supply (i.e. battery) electrical leads (1 voltage and 1 ground) 130 and 9 signal electrical leads (8 drive signals for each phase level and 1 ground) 120 are shown connected to the IC. The IC is capable of providing separate voltages to each signal electrical lead based upon the desired phase level. The number of signal electrical leads depends upon the configuration of the EA element (discussed below) and may be, by way of example only, as few as 3 or as many as 34. The width of the leads depends on the available space, the number of leads required, and the width of the inter-lead space required for electrical isolation. By way of example only, leads 100 82 m wide with 100 μm spaces may be used for the signal electrical leads whereas 300 μm wide leads with 300 μm wide spaces may be used for the battery electrical leads. The signal electrical leads connect to the EA element's patterned electrodes by means of an electrical contact. In embodiments of the invention in which the EA element is a diffractive lens with patterned, concentric ring electrodes, it is the relative size (radius and width) of the patterned electrodes within the element that defines the optical add power of the diffractive grating structure. The separate amplitudes of the voltages applied by the IC to the separate electrical signal leads (and thus to the patterned electrodes) determine the phase profile produced in the layer of liquid crystal and as such, determine the diffraction efficiency (fraction of the incident light that is focused) of the EA element. As such, a single IC design with a single SKU number assigned to it may be used to drive any EA element regardless of the optical add power it provides. In embodiments of the invention in which the EA element is a pixelated, patterned electrode device, the optical power and/or aberration correction is completely dynamic and determined by the pattern of voltages addressed to the array of pixels. In embodiments of the invention in which the EA element is a modal lens, it is the amplitude of the voltage applied to the high conductivity ring electrode that defines the optical add power, where, generally, the higher the applied voltage the larger the amount of optical add power. In embodiments of the invention where the EA element is a surface relief optic, the optical power/aberration correction is fixed by the pattern transferred into the substrate but the optic is made dynamic by means of voltage applied to create refractive index matching and mismatching.

To facilitate the connection of the insert 110 to the external power source, a small electrical connector (not shown) may also be attached to the insert. Compared to making contact to the thin film battery electrical leads 130 after the lens is fully assembled, such a connector would be far more physically robust and would help reduce the number of manufacturing steps. Such a connector, if made from a combination of sufficiently soft materials that are both electrically insulating and conducting, could be designed to be machined flush with the edge of the lens using existing edging tools and still provide an acceptable electrical connection. By way of example only, the connector could be a small block of plastic with a refractive index closely matched to that of the bulk lens material that contains wires made from copper (a soft metal) that are bonded to the battery leads using appropriate means such as a conductive adhesive. After the bulk lens (also made from plastic) is formed around the insert and connector, the machining step typically used to form the outer peripheral edge of a finished lens would be able to easily cut through the small plastic block and the copper wires, exposing the wires for a subsequent connection to a power source.

The integration insert 110 has been designed with multiple mounting positions such that the IC 140 may be placed at various radial distances from the center of the EA element 150 to accommodate the varied sizes of available spectacle lens frames. Thus, there will always be an appropriate radial distance from the center of the EA element where the IC can be mounted so that it will not be cut off when the lens is edged to the proper size. Three ICs are shown mounted to the insert for illustration purposes only; in practice only one IC should be required. Furthermore, fabricating only a single insert with multiple IC mounting positions reduces the number of stock keeping units (SKUs).

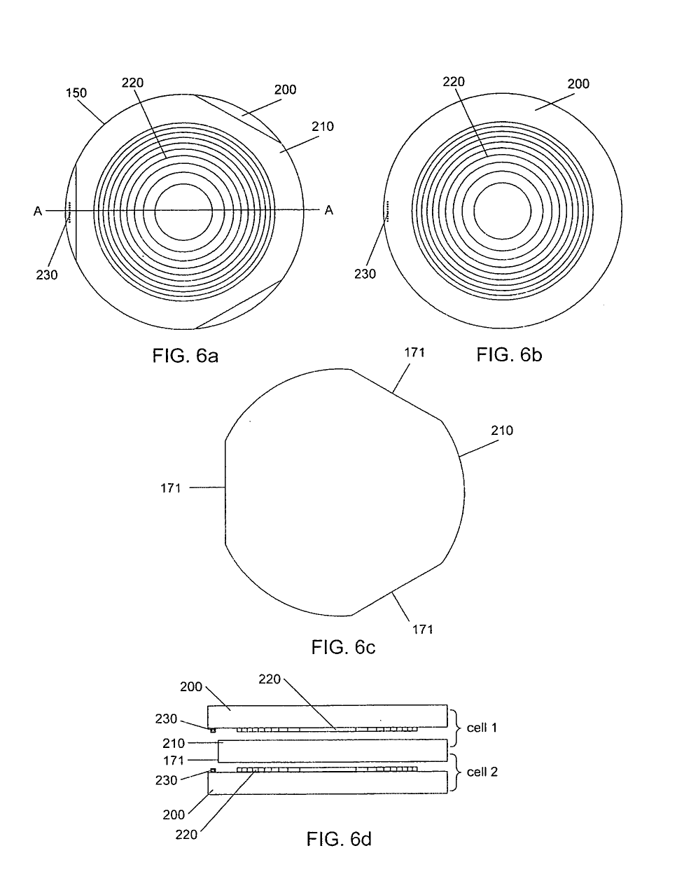

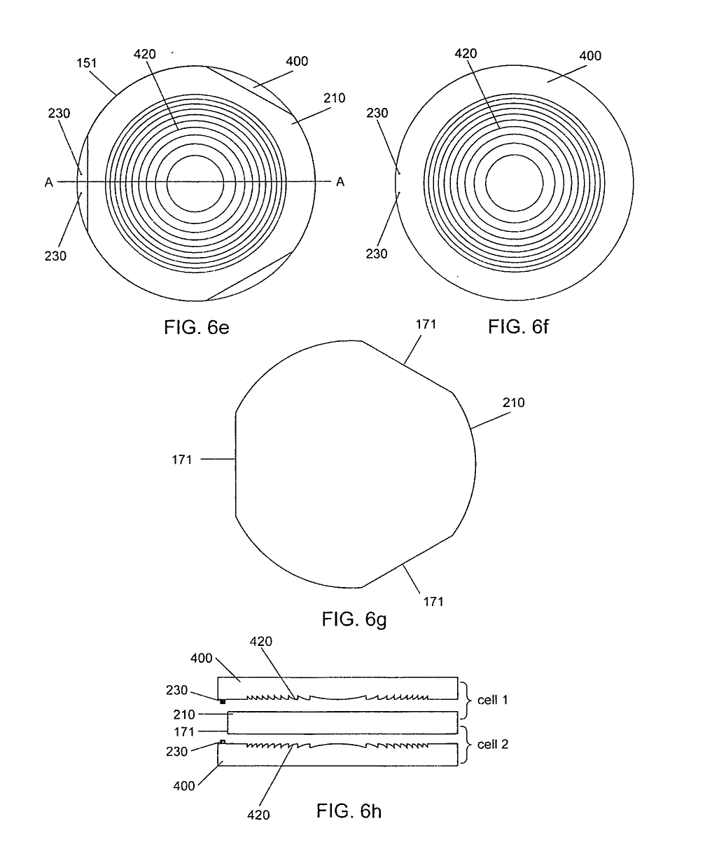

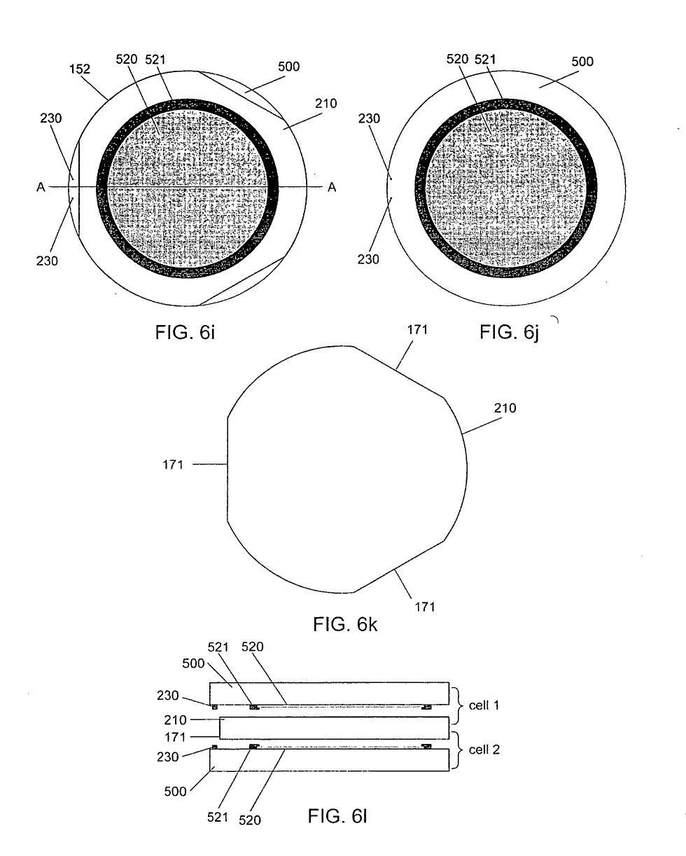

The EA element 150 and its constitutive components are shown in FIGS. 6a-6c. The EA element is comprised of substrates which, by way of example only, may be made from inorganic materials such as glass or sapphire or organic materials such as acrylates, a class of materials typically used to form ophthalmic lenses. In an embodiment of the invention, a total of three substrates may be used to construct the EA element. In such an embodiment, two substrates 200 have photolithographically patterned transparent electrodes 220 on one surface (FIG. 6b) and one substrate 210 has a single continuous transparent electrode (FIG. 6c) on both surfaces, which acts as the reference (ground). In another embodiment of the invention only two substrates are used. In such an embodiment, one substrate 200 has photolithographically patterned transparent electrodes 220 on one surface (FIG. 6b) and one substrate 210 has a single continuous transparent electrode (FIG. 6c) on one surface, which acts as the reference (ground). As discussed previously, electrodes can be patterned as concentric rings to generate optical add power (to correct for presbyopia) or in an array of pixels to correct for any arbitrary optical error of the eye, including, by way of example only, presbyopia and higher-order aberrations.

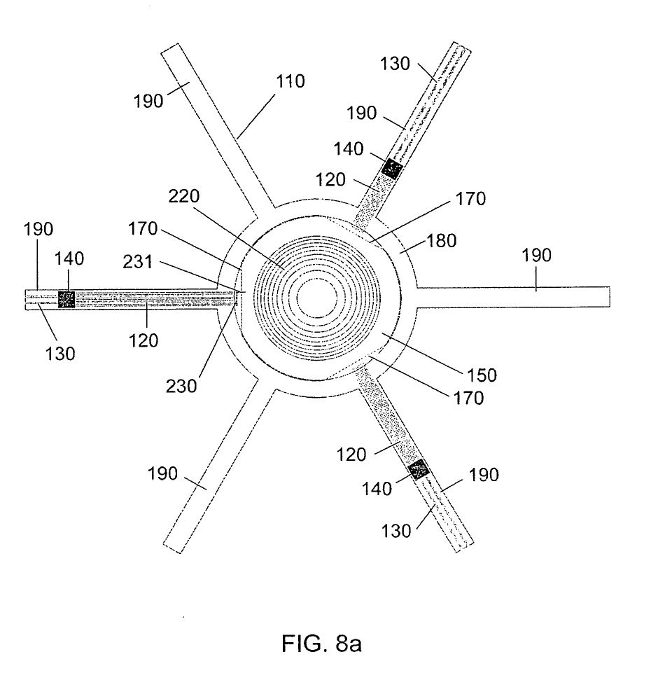

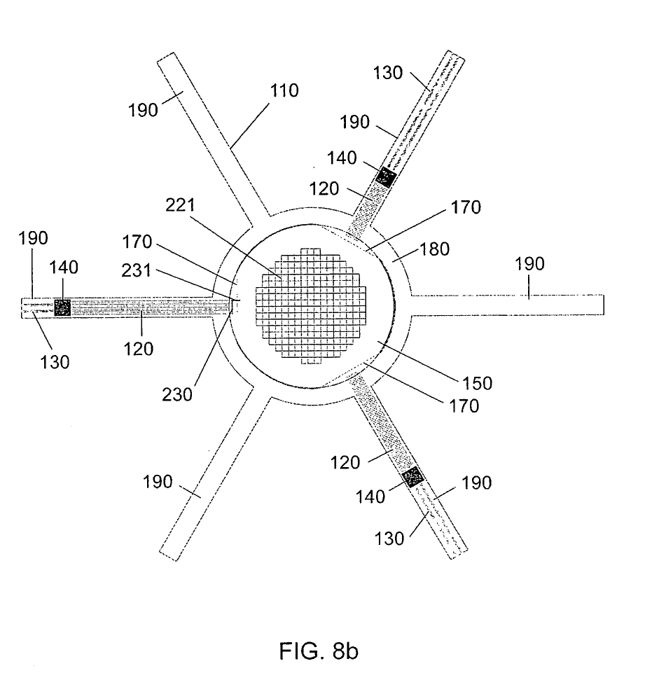

In embodiments of the invention with patterned, concentric ring electrodes 220, the EA element provides optical add power whereby the patterned electrodes 220 act to define a multi-level diffractive lens structure in a thin layer of liquid crystal. When using a multi-level diffractive optic, each signal electrical lead is used to drive multiple patterned concentric ring electrodes so as to produce the correct phase profile in the layer of liquid crystal. While only 10 patterned electrodes are shown for simplicity (FIG. 6a), a typical lens may contain, by way of example only, up to 3000 individual electrodes of varying widths from 1 μm to 100 μm, by way of example only. In embodiments of the invention with a pixelated EA element (FIG. 8b), the number of pixels could be, by way of example only, as few as 100 or as many as 1,000,000. The size of each pixel varies and can fall within the range of 1 μm to 1 mm, by way of example only.

In another embodiment of the invention an alternate EA element 151 is shown (FIG. 6e) which uses two substrates 400 with surface relief optics (shown here, by way of example only, as diffractive lenses) 420 coated with a single continuous electrode (not shown) instead of planar substrates 200 with patterned electrodes 220. In this alternate embodiment, surface relief optics, which are well known in the art, generate the desired amount of optical power and the layer of liquid crystal is used as a dynamic refractive-index matching material. Under a first applied voltage the refractive index of the liquid crystal is substantially the same as (matches) the refractive index of the substrate 400 and there is substantially no diffraction. Instead, incident light only experiences a single refractive index as if the EA element were a planar layer of homogeneous material. Under a second applied voltage the refractive index of the liquid crystal is different from (mismatches) the refractive index of the substrate 400 and there is diffraction of the incident light due to the resulting phase difference generated by the index mismatch. In a preferred embodiment of the invention refractive index matching is achieved when zero voltage is applied to the EA element as this renders it fail safe (zero optical add power under zero applied voltage). A non fail-safe lens is undesirable as the sudden introduction of optical power at an inappropriate time (e.g. while driving) can be dangerous to the wearer. Surface relief optics which generate optical add power are shown by way of example only, in other embodiments they can be used to generate phase profiles similar to those that can be generated by a pixelated EA element with patterned electrodes.

Alternate EA element 151 is constructed from two substrates 400 with surface relief optics 420 coated with a single continuous electrode (FIG. 6f) and one substrate 210 with a single continuous transparent electrode (FIG. 6g) on both surfaces, which acts as the reference (ground). The one substrate with the silgle continuous transparent electrode on both surfaces (FIG. 6g) is identical to substrate 210 that is used for the EA element with patterned electrodes. An exploded view of FIG. 6ealong the axis A-A is shown in FIG. 6h, where the surface relief diffractive structure is clearly visible. One benefit of this embodiment is that as the inner surface of each substrate now only contains a single continuous electrode, the number of electrical contact points 230 is reduced to four, two to make the electrical ground connections and two to make the drive voltage connections. In another embodiment of the invention only two substrates are used. In such an embodiment, one substrate 400 has surface relief optics 420 on one surface (FIG. 6f) and one substrate 210 has a single continuous transparent electrode (FIG. 6g) on one surface, which acts as the reference (ground).

In yet another embodiment of the invention, alternate EA element 152 is constructed from two substrates 500 with modal lens electrodes (FIG. 6j) and one substrate 210 with a single continuous electrode on both surfaces, which acts as the reference (ground), (FIG. 6k). Modal lens electrodes consist of a single, continuous circular electrode 520 comprising a low conductivity material and a single; continuous ring electrode 521 comprising a high conductivity material. The one substrate with the single continuous transparent electrode on both surfaces (FIG. 6k) is identical to substrate 210 that is used for the EA element with patterned electrodes. An exploded view of FIG. 6i along the axis A-A is shown in FIG. 61, where electrical connection between the low-conductivity electrode 520 and high-conductivity electrodes 521 is shown. One benefit of this embodiment is that as the inner surface of each substrate flow only requires a single electrical contact to the high conductivity ring electrode, the number of electrical contact points 230 is reduced to four, two to make the electrical ground connections and two to make the drive voltage connections. Electrical connection between the contact points 230 and the high-conductivity ring electrode 521 is made, by way of example only, by means of a transparent thin-film electrode or conductive adhesive lead (not shown). In another embodiment of the invention only two substrates are used. In such an embodiment, one substrate 500 has modal lens electrodes 520 and 521 on one surface (FIG. 6j) and one substrate 210 has a single continuous transparent electrode (FIG. 6k) on one surface, which acts as the reference (ground).

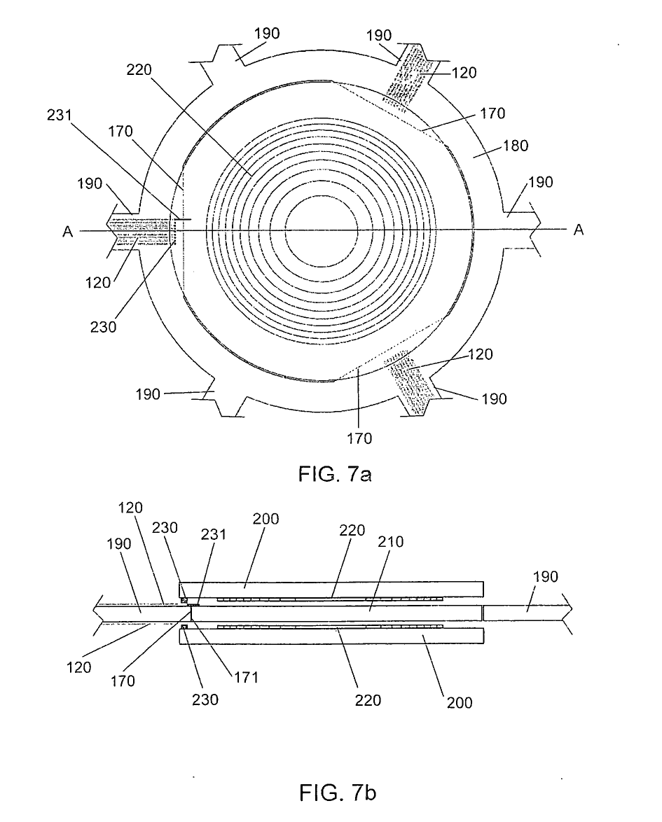

Substrates 200, 400 and 500 have electrical contact points 230 near the periphery which make connection to the patterned electrodes 220, 420 and 521, respectively, using a system of conductive thin-film buses (not shown) and which are designed to align with the signal electrical leads 120 placed on the integration insert 110. In embodiments of the invention in which two substrates 200, 400, or 500 are incorporated into the EA element, the insert may have signal electrical leads placed on both surfaces which may be used to make contact with the electrical contact points 230 on the surfaces of both substrates 200, 400 or 500. In such an embodiment, one integrated circuit 140 may be placed on each side of the integration insert 110 or electrical connection can be made from one integrated circuit to both sides of the insert by means of electrical vias in the insert. Electrical vias are well known in the art and consist of physical openings in a layer of electrically insulating material which contain electrically conductive materials to enable discrete electrical connections across the thickness of the electrically insulating material. Electrical connection between the reference (ground) substrate and the integration insert is made, by way of example only, by a wire bond or conductive epoxy trace 231 as shown in FIGS. 7a-7b. The proper orientation of the EA element within the integration insert is facilitated by the alignment edges 171 along the periphery of the reference substrate 210, which register to the corresponding structures 170 on the integration insert 110. Preferably, the integration insert and the EA element are designed to have rotational symmetry with respect to their alignment edges. Thus, electrical connection between the EA element and the integration insert may be made along any of the integration insert's alignment edges 170 which has signal electrical leads terminate near it and any of the EA element's alignment edges 171 which has electrical contact points.

To assemble the EA element 150, every substrate surface containing an electrode is treated with liquid crystal alignment layers (not shown, but are well known in the art) to induce a given direction of liquid crystal alignment. Thus, substrate 200 will have the surface containing the patterned electrodes treated with a liquid crystal alignment layer and substrate 210 will have both surfaces containing the single continuous electrode treated with a liquid crystal alignment layer. Liquid crystal alignment layers are thin films (typically <100 nm thick) of a polyimide material which are applied to those surfaces which come into direct contact with liquid crystal. The surfaces of these films are, prior to EA element assembly, rubbed or buffed in one direction with a cloth such as velvet (a technique well known in the art). When liquid crystal molecules come into contact with Such a surface, the molecules preferentially lie in the plane of the substrate and are aligned in the direction in which the polyimide layer was rubbed. This process is the same for all EA elements regardless if concentric ring electrodes, pixelated electrodes, modal lens electrodes, or Surface relief structures are used.

In embodiments of the invention in which nematic liquid crystal is used, three substrates must be used in order to overcome the fact that nematic liquid crystals are polarization sensitive (i.e. light of different polarizations experience different refractive indices as they travel through the material). Subsequent to preparing the alignment layers, the three substrates are then stacked to allow the formation of two liquid cells (a cell being both a layer of liquid crystal and the two substrate surfaces between which it is confined). For the sake of clarity, the layers of liquid crystal are not shown in the drawings. The two substrates with patterned electrodes 200 are placed on either side of the substrate containing the single continuous electrode 210, such that the substrate surfaces with patterned electrodes face the substrate surfaces with the continuous electrode. Thus, the inner surfaces of the two cells each posses a reference electrode and a patterned electrode. The substrates are stacked in such a way that within a given cell, the directions of liquid crystal alignment induced by the two alignment layers are anti-parallel (directions differ by 180°) but that the directions of alignment of one cell are orthogonal to those of the second cell. This anti-parallel and orthogonal arrangement of the alignment layers enables operation of an EA element with nematic liquid crystal in unpolarized ambient light. An assembled EA element according to this embodiment of the invention can be seen in FIG. 6a. FIG. 6d shows an exploded view of FIG. 6a along the axis A-A. The polarization sensitivity of nematic liquid crystals is independent of all the aforementioned configurations of the EA element and the use of two, orthogonally aligned layers is required for all EA elements regardless if concentric ring electrodes, pixelated electrodes, modal lens electrodes, or surface relief structures are used.

In another embodiment of the invention the use of a polarization insensitive cholesteric liquid crystal would eliminate the need for a second layer of liquid crystal and, if such were the case, only two substrates, one with patterned electrodes and another with a continuous reference (ground) electrode, would be needed. Cholesteric liquid crystals are a class of materials similar to nematic liquid crystals in that their constituent molecules tend to orient in a single direction, but differ in that the preferred direction of orientation twists along a given axis within the material. If the twist pitch (distance along said axis over which the preferred direction of orientation rotates by 360°) is on the order of, or less than, the wavelength of light, then the light may see a refractive index that is nearly independent of its polarization. As with an EA element with nematic liquid crystal, alignment layers are placed on the substrate surfaces containing electrodes. However, it is no longer necessary to align the substrates such that the alignment layers are anti-parallel. Additionally, because there is only one cell, an orthogonal relationship between cells is not necessary or possible. In a preferred embodiment of the invention, polarization insensitive cholesteric liquid crystals are used in conjunction with the alternate EA element shown in FIGS. 6e-6h which utilize surface relief diffractive lenses. This embodiment is preferred as it requires only two substrates (one substrate 400 and one substrate 210), a single layer of electro-active material, and two electrical contact points, greatly simplifying the fabrication of the EA element. This process is the same for all EA elements regardless if concentric ring electrodes, pixelated electrodes, modal lens electrodes, or surface relief structures are used.

The overall thickness of the fully assembled EA element should be less than 200 μm (and be comparable to the thickness of the integration insert) so as to reduce the thickness of the finished EA spectacle lens. For example, when building a polarization insensitive EA element with two, 5 μm layers of nematic liquid crystal, the thicknesses of the 3 individual substrates should be less than 60 μm (3×60 μm+2×5 μm=190 μm). In a more preferred embodiment of the invention the total thickness of the EA element may be 600 μm or less to allow for easier fabrication. For example, when building a polarization insensitive EA element with two, 5 μm layers of nematic liquid crystal, the thicknesses of the 3 individual substrates should be less than 196 μm (3×196 μm+2×5 μm=598 μm). The fabrication of individual EA elements of various focal lengths (optical add powers) also helps to further streamline the manufacturing process. Fabricating the EA element separately from the integration insert reduces the number of SKUs as now there is no need to create a SKU number for each combination of optical add power and IC location; there only needs to be a SKU number for the insert, the IC, and each optical add power value, an additive as opposed to multiplicative calculation.

The assembled EA element is placed at the center of the integration insert 110 such that the electrical contact points 230 on the substrates align with the corresponding electrical leads 120 on the integration insert 110 (FIG. 7a-7b), a process which is facilitated by the alignment edges 171 on the reference substrate 210 and the alignment edges 170 on the integration insert. Electrical connections between the EA element and the insert can be made by a number of methods including (but not limited to) conducting adhesives, metal bump-bonding and wire bonding. Incorporating the EA element into the insert can be accomplished in a number of ways. An example of an assembled EA element with patterned, concentric ring electrodes incorporated into an integration insert is shown in FIG. 8a. An example of an assembled EA element with patterned, pixelated electrodes incorporated into an integration insert is shown in FIG. 8b. This process is the same for all EA elements regardless if concentric ring electrodes, pixelated electrodes, modal lens electrodes, or surface relief structures are used.

In one embodiment of the invention with three substrates, the reference substrate 210 is placed at the center of the insert and electrical contact is made between the reference substrate and the ground signal electrical lead. Then, the substrates with patterned electrodes 200 are attached, by means of an optically transparent adhesive such as NOA65 (Norland Products) to either side of the reference substrate 210 such that the electrode surfaces face each other. Before the substrates are attached, liquid crystal alignment layers are applied and the cells are oriented as explained above. The cells could then, in no particular order, be filled with liquid crystal and connected, via contact points 230, to the signal electrical leads on the insert. This process is the same for all EA elements regardless if concentric ring electrodes, pixelated electrodes, modal lens electrodes, or surface relief structures are used.

In another embodiment of the invention with three substrates, only one of the two cells (comprising the reference substrate 210 and one substrate with patterned electrodes 200) is assembled (as explained above) and electrically connected to the insert. Subsequently, the second substrate with patterned electrodes 200 is properly oriented and attached to the opposite side of the reference substrate and electrical connections are made. In this embodiment the cells could be filled with liquid crystal as they are assembled or after both have been assembled. This process is the same for all EA elements regardless if concentric ring electrodes, pixelated electrodes, modal lens electrodes, or surface relief structures are used.

In another, less preferred embodiment of the invention with three substrates, the EA element, regardless of its configuration, is completely assembled and incorporated within the flexible integration insert by means of bending or otherwise temporarily physically deforming the insert such that the EA element will fit within the opening.

In embodiments of the invention utilizing an EA element incorporating a polarization insensitive cholesteric liquid crystal, only two substrates are required, one with a reference electrode and one with patterned electrodes. In such an embodiment, incorporation of the two substrate EA element is greatly simplified as the EA element may be fully assembled before hand, where making the electrical connections to the insert is the only remaining processing step. This process is the same for all EA elements regardless if concentric ring electrodes, pixelated electrodes, modal lens electrodes, or surface relief structures are used.

The use of multiple components in the assembly of the integration insert will require the use of an encapsulating adhesive or resin to both physically stabilize the fully assembled insert (which includes the EA element) and to form at least one of the finished surfaces of the final lens. It should be pointed out that the use of the term finished lens blank denotes an optic that is finished on both sides and has a defined optical power. A semi-finished lens blank is finished on one side and lacks a defined optical power. An unfinished lens blank could be either semi finished or have neither side finished. The term wafer can mean either a thin semi-finished lens blank or a finished lens blank. Finally, the term blank denotes that such lens article has not been edged or shaped into the final shape of the spectacle lens frame.

It should be further pointed out that the finished lens is fabricated in such a way as to correct for the conventional optical errors of sphere and cylinder or in an inventive approach, to correct for higher order aberrations. The fabrication of lenses which correct for conventional refractive errors of sphere and cylinder is well known in the art. To correct higher order aberrations of the human eye, the optical power of the lens will be fabricated to have localized optical power changes that will correct for the higher order aberration or aberrations specified in terms of type, power, and position. In most cases, the higher order aberration correction is determined by way of a wave-front analysis of the eye of the wearer of said finished electro-active spectacle lenses. The higher order aberration correction can be accomplished by producing localized changes in optical power of said lens blank and can be imparted by way of machining an exposed, external surface to which the electro-active layer is not affixed. It is to be understood that machining can include the process of surfacing and polishing the lens. Alternatively, localized changes can be imparted by way of curing a thin resin layer that is contained within said lens blank such as to cause localized index changes in the lens blank. The localized changes can also be imparted when adding the elect-o-active layer to the lens blank by imparting the localized changes by way of curing the surface-casting resin layer between said lens blank and around the electro-active layer. Higher order aberration correction can also be accomplished with the use of a pixilated optic as shown in FIG. 8b.

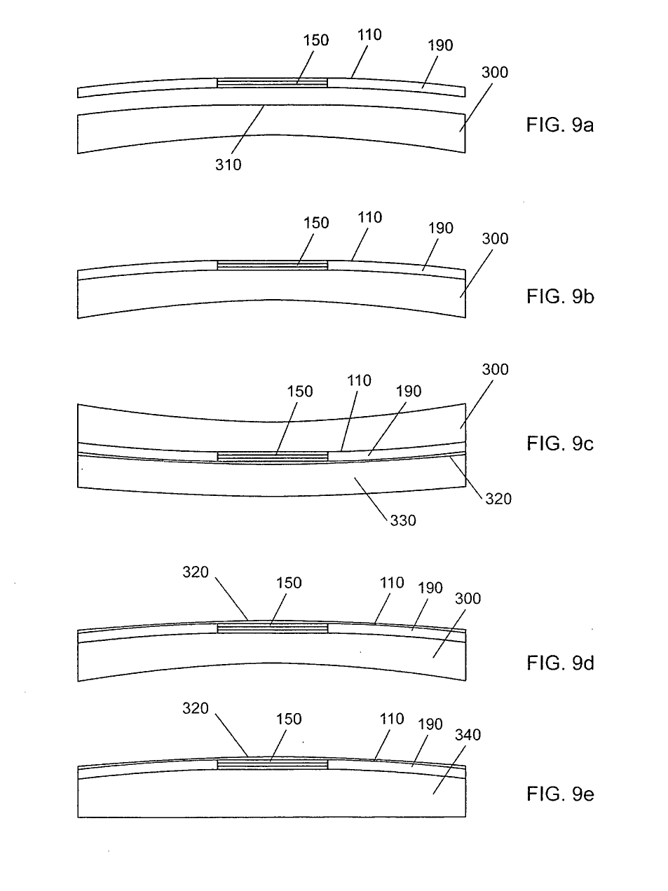

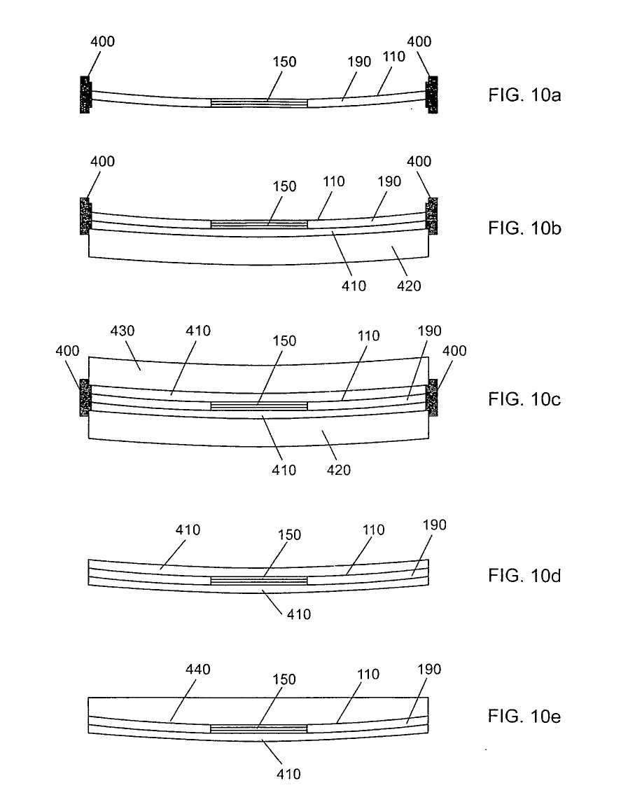

Two approaches for incorporating the integration insert 110 with the bulk refractive element 160 are shown in FIGS. 9a-9e and FIGS. 10a-10e. The first approach utilizes a plastic, finished lens blank 300 with a flat region 310 near the center (FIG. 9a) to which the assembled insert 110 is laminated with an optically clear adhesive (FIG. 9b). The flat region 310 near the center will help restrict any possible bending of the EA element 150, which may distort the liquid crystal layer and lead to reduced performance. This sub-assembly is then inverted and placed into a mold 330 that defines the other finished surface of the lens. The mold 330 is then filled with a UV or heat sensitive resin 320 and cured (FIG. 9c). After the resin 320 is cured, the lens is removed from the mold 330 (FIG. 9d) and is ready for any additional processing required to fit it into a suitable spectacle lens frame. Techniques for the “surface casting” of optical quality surfaces are known in the art. It should be noted that while the material from which the finished lens blank 300 or semi-finished lens blank 340 is manufactured may not be the same material used in the surface cast layer 320, the two materials should have substantially the same refractive index.

The lens blank employed in the above method may be either finished or semi-finished. Incorporating the insert with a finished blank 300 eliminates the need for any post-lamination mechanical grinding/polishing of optical surfaces but requires knowledge of the patient's prescription and frame shape (i.e. a custom product). The use of semi-finished blanks 340 (FIG. 9e) will require a post-lamination mechanical grinding/polishing step but does not require any knowledge of the patient's prescription. This would be the preferred approach as semi-finished lenses could be sold directly to wholesale laboratories and in doing so, would not interrupt the established flow of goods and information from lens manufacturer to patient.

As an alternative to the lamination method, the integration insert 110 may be cast within a volume of cured resin that forms the distance vision lens. Techniques for casting whole lenses from liquid resins are also known in the art. The casting of an EA lens can be accomplished by first mounting the arms 190 of the insert 110 to a rigid mounting ring/mold gasket 400 as shown in FIG. 10a. The rigid ring 400 is then mounted (temporarily) to a mold 420, whose surface defines one of the finished surfaces of the EA lens (FIG. 10b). A second mold 430 is then mounted to the rigid ring 400 in a similar fashion such that a cavity is formed, with the integration insert 110 suspended between the two mold surfaces (FIG. 10c). The cavity is then filled with a suitable resin 410 and cured. After the resin 410 is cured the molds 420 and 430 and rigid ring 400 are removed and the resulting lens is ready for any additional processing required to fit it into a suitable spectacle lens frame (FIG. 10d). To facilitate the manufacturing process, the rigid mounting ring/mold gasket 400 may be made from an inexpensive, injection moldable material such that it is disposable. As with the lamination method, a molded semi-finished blank 440 (FIG. 10e) can be used instead of a finished mold blank. Either a finished or semi-finished EA lens may be produced with this method; with the production of a semi-finished lens preferred for the aforementioned reasons.

A benefit of these two approaches is that the parameters of the fully assembled EA component are both independent of and insensitive to any requirements on the patient's distance and/or astigmatic vision correction. While a patient's prescription is required to manufacture finished lenses (by either lamination or casting) the rotational symmetry of the insert allows it to be oriented in such a way that the IC is placed in an aesthetically acceptable location that is independent of the patient's astigmatic axis. Manufacturing semi-finished lenses (by either lamination or casting, FIG. 9e and FIG. 10e) is even more forgiving as the distance/astigmatic correction is added after the lens is manufactured. The lack of correlation between the near and distance vision corrections and the rotational symmetry of the integration insert allows well-established lens manufacturing and processing technologies to be utilized with only minor modifications for the incorporation of the EA technology. The manufacture of semi-finished blanks by either of the previously mentioned methods allows the use of a technique known as free-forming to generate the finished lens from the semi-finished blank. Free-forming is a form of computer numerical control (CNC) machining used to grind and polish the patient's prescription into a surface of the semi-finished lens blank and is well known in the art. Free forming has the advantage that while it is commonly used to generate surfaces for distance vision correction, in certain embodiments of the current invention it can also be used to generate surfaces for the correction of higher-order aberrations.

While these two methods offer many benefits for manufacturing EA spectacle lenses, their success depends on the ability to match the refractive indices of all the optical materials and components involved. If the refractive indices are not all equal (within a margin of error of ±0.02) then the edges of the integration insert and EA element may be visible and the product will not be acceptable to the patient. Fortunately, there are many optical materials that can exhibit a wide range of refractive index values and are compatible with different processing technologies. One limitation however, is that the use of conventional photolithography (and its associated organic solvents) to define the patterned EA electrodes make inorganic materials better candidates for substrate materials. By way of example only, suitable inorganic materials include glass and sapphire where glass would be preferred over sapphire due to the high cost of sapphire. Still, with proper care and selection of solvent used in the processing of the electrodes, organic materials such as films formed from acrylates may be used to make EA elements. Glass manufacturers for the optics industry such as Schott, Hoya, and Ohara supply glasses with refractive indices that range from slightly below 1.50 to slightly above 2.00, values which overlap well with the needs of the ophthalmic industry. Refractive indices of various monomers (resins) and polymers (plastics) also cover a wide range of values but do not currently achieve values as high as those of the optical glasses. Typical “large” refractive indices for commercial optical resins and plastics are on the order of 1.60 to 1.70- values which are primarily driven by the ophthalmic industry. Given the broad range of overlap in refractive index values for the various materials the index matching requirement appears to present no major challenges. There are however, preferred ranges for the refractive index. Many optical materials tend to have refractive indices near to 1.50 and in one embodiment of the invention; the refractive index of the individual components is matched to a value near to 1.50. If polarization insensitive cholesteric liquid crystals are used, which have a refractive index of approximately 1.66, then in another embodiment of the invention the refractive index of the individual components is matched to a value near to 1.66. In an effort to reduce the number of individual components that need to be index matched, in certain embodiments of the invention, one of the substrates used to construct the EA element may be replaced by either a finished lens blank or a semi-finished lens blank when the lamination method of lens construction is used. In such an embodiment, the construction of the complete integration insert will include the finished or semi-finished lens blank.

The above outlines a method for manufacturing EA spectacle lenses that correct for presbyopia by the use of a liquid crystal based dynamic, electro-active lens embedded within a conventional spectacle lens that provides distance vision correction. While this invention is targeted at correcting presbyopia, the methods presented could be used to construct spectacle lenses that correct for other vision errors, such as higher order aberrations of the eye.

What is claimed:

1. An electro-active spectacle lens, comprising:
an optical element for providing a first optical power;
an insert, disposed within said optical element; and
an electro-active element in optical communication with said optical element and positioned in contact with said insert for providing a second optical power when activated and substantially no optical power when deactivated.

2. The lens of claim 1, wherein said optical element comprises:
a finished lens blank for forming a first surface of said optical element; and
a shaped optical resin for forming a second surface of said optical element opposite said first surface.

3. The lens of claim 1, wherein said optical element comprises:
a semi-finished lens blank for forming a first surface of said optical element; and
a shaped optical resin for forming a second surface of said optical element opposite said first surface.

4. The lens of claim 1, wherein said optical element comprises:
a shaped optical resin for forming a first and a second surface of said optical element,
wherein said second surface is opposite said first surface.

5. The lens of claim 1, wherein said first optical power is selected from the group consisting of:
piano optical power, spherical optical power, cylindrical optical power, and sphero-cylindrical optical power;
and wherein said second optical power is selected from the group consisting of:
piano optical power and spherical optical power.

6. The lens of claim 1, wherein said first optical power corrects for vision problems selected from the group consisting of:
myopia, hyperopia, presbyopia, and astigmatism;
and wherein said second optical power corrects for vision problems selected from the group consisting of:
myopia, hyperopia, and presbyopia.

7. The lens of claim 1, wherein said optical element is adapted for correcting a higher order aberration of the eye.

8. The lens of claim 1, wherein said electro-active element is adapted for correcting a higher order aberration of the eye.

9. The lens of claim 1, wherein said insert comprises:
a central ring for said positioning of said electro-active element;
a peripheral material disposed radially about said central ring; and
an electrical pathway positioned on said peripheral material for providing electrical communication along said peripheral material to said central ring.

10. The insert of claim 9, wherein said peripheral material comprises a plurality of arms disposed radially about said central ring.

11. The insert of claim 9, wherein the electrical pathway comprises:
a plurality of signal electrical leads disposed in said central ring and extending along said peripheral material;
an integrated circuit electrically connected to said signal electrical leads for providing electrical power to said electro-active element; and
a pair of battery signal leads electrically connected to said integrated circuit and distally disposed from said plurality of signal electrical leads along said peripheral material.

12. The lens of claim 1, wherein the electro-active element comprises:
a first substrate;
a plurality of patterned electrodes disposed upon a surface of said first substrate;
a second substrate disposed upon said first substrate;
an electrode disposed upon a surface of said second substrate; and
a liquid crystal disposed between said patterned electrodes and said electrode.

13. The lens of claim 1, wherein the electro-active element comprises:
a first substrate;
a first plurality of patterned electrodes disposed upon a surface of said first substrate;
a second substrate disposed upon said first substrate;
a first electrode disposed upon a first surface of said second substrate;
a second electrode disposed upon a second surface of said second substrate, wherein said second surface is opposite said first surface;
a third substrate disposed upon said second substrate;
a second plurality of patterned electrodes disposed upon a surface of said third substrate;
a first liquid crystal disposed between said first plurality of patterned electrodes and said first electrode; and
a second liquid crystal disposed between said second plurality of patterned electrodes and said second electrode.

14. The lens of claim 1, wherein the electro-active element is adapted for providing an optical add power.

15. The lens of claim 1, wherein the electro-active element is a diffractive concentric ring electro-active element.

16. The lens of claim 1,.wherein the electro-active element is a pixilated electro-active element.

17. The lens of claim 1, wherein the electro-active element is a surface relief electro-active element.

18. The lens of claim 1, wherein the electro-active element is a modal lens electro-active element.

19. A method for manufacturing an electro-active spectacle lens, the method comprising:
positioning an electro-active element within an insert for forming an assembled insert;
laminating a lens blank to a first face of said assembled insert with an optically transparent adhesive for producing a first optical surface of the electro-active spectacle lens;
positioning a mold over a second face of said assembled insert opposite said first face for forming a cavity between said mold and said lens blank;
filling said cavity with an optical resin; and
curing said optical resin for producing a second optical surface of the electro-active spectacle lens.

20. The method for manufacturing the lens of claim 19 wherein said lens blank comprises a finished lens blank.

21. The method for manufacturing the lens of claim 19 wherein said lens blank comprises a semi-finished lens blank.

22. A method for manufacturing an electro-active spectacle lens, the method comprising:
positioning an electro-active element within an insert for forming an assembled insert;
mounting said assembled insert within a mold gasket;
positioning a first mold and a second mold on said mold gasket, wherein said first mold is opposite said second mold for forming a cavity between said first mold and said second mold;
filling said cavity with an optical resin; and
curing said optical resin for producing a first and a second optical surface of the electro-active spectacle lens.

23. The method for manufacturing the lens of claim 22 wherein said first optical surface comprises a finished lens blank.

24. The method for manufacturing the lens of claim 22 wherein said first optical surface comprises a semi-finished lens blank.

25. The semi-finished lens blank of claims 21 and 24, wherein said semi-finished lens blank is further processed for forming a finished lens blank.

26. The lens of claim 1, wherein said electro-active element comprises:
a first substrate;
a second substrate; and
a material capable of having its index of refraction altered electronically disposed between said first substrate and said second substrate.
